(19) United States
(12) Patent Application Publication
(10) Pub. No.: US 2009/0182579 A1
(43) Pub. Date: Jul. 16, 2009

(54) METHOD OF PROCESSING GENOMIC INFORMATION

(76) Inventor: Edison Liu, Singapore (SG)

Correspondence Address: DICKSTEIN SHAPIRO LLP, 1825 EYE STREET NW, Washington, DC, 20006-5403, US

(21) Appl. No.: 11/972,495

(22) Filed: Jan. 10, 2008

(51) Int. Cl. G06Q 50/00

(52) U.S. Cl. 705/3

(57) ABSTRACT

The present invention relates to a method for processing and/or providing genomic, proteomic, biochemical, and/or metabolic information collected from at least one subject wherein the processing and/or providing of the information is under the control of the subject. There is also provided an apparatus and a system for processing and/or providing of genomic, proteomic, biochemical, and/or metabolic information.

### FIELD OF INVENTION

The present invention relates to a method, apparatus and/or system for processing and/or providing genomic, proteomic, biochemical, and/or metabolic information.

### BACKGROUND OF THE ART

Methods of genetic analysis are well known in the art. The ability to sequence DNA to unlock the genetic code of any organism has been one of the profound advances in scientific history. The explosion in genome analysis in the recent years have further enabled sequencing of single fragments using highly multiplex platforms of up to a billion sites simultaneously. The new approaches have thus increased the speed and capacity of sequencing. “Genotyping” or “haplotyping”, together with genomic and proteomic analysis have lead to the identification of certain genes, alleles, haplotypes, or other genetic indicia or loci that are connected or related in some way to certain diseases or conditions, or that may be suitable targets for drugs or gene therapy.

Currently, patients that require genetic testing are assessed on a gene-to-gene and disease by disease basis. Such sequential tests result in fragmented care with the results from the multiple tests being stored in different hospitals and/or medical institutes. Consequently, it is inconvenient for the patient to access these results when need be and it is inefficient for doctors to obtain the medical history of a patient if the information is scattered and found in multiple places. The doctor and/or patient will never know if he/she has the complete information with regard to the medical history of a patient. Therefore, one can not be sure if the diagnosis based on the medical history obtained is indeed accurate.

Furthermore, since the tests are carried on a gene-to gene and disease by disease basis, a patient needs to undergo multiple tests to diagnose multiple diseases. Each of these tests requires the availability of a new DNA sample to determine the presence of a disease. There is thus no option for examining further genetic information and diagnosing the possibility of other diseases from just a single DNA sample obtained from the patient. The patient will have to provide a new DNA sample each time a disease is to be diagnosed and tested for. This again is inconvenient, expensive and time-consuming for both the patient and the doctor carrying out the tests.

Moreover, such multiple tests cannot capture the new developments in the biomedical research and are heavily dependent on the availability of tests in the market. The patients are only informed of tests that are available in the market and that are offered by the hospitals and/or medical institutes. These tests offered to the patients are usually only those that have been approved by the hospital and/or medical institutes to be carried out on patients. The selection of tests available to the patient may thus be heavily dependent on decisions made by the hospital boards, funding provided and the like. These available tests are seldom part of cutting edge technology and the patient may also not be informed and/or given the opportunity to select tests which capture the new developments in the biomedical research which are just not as popular yet.

Furthermore, since many diseases are polygenic in etiology and are usually a result of the change in expression of many genes, a single test to determine the genetic differences found in a single gene may not be sufficient to diagnose a disease. In the currently available methods, multiple tests would have to be carried out in an attempt to deliver the whole genetic picture of the patient's predisposition to a certain disease. Even then, the currently available methods neither delivers the complete information with regard to a patient's predisposition to a certain disease nor do they provide sufficient information on the etiology of the disease. However, in order to carry out these tests, it would require several samples of the patient's DNA and is inconvenient, time-consuming and expensive for the patient and/or medical officer carrying out the tests.

The currently available methods for obtaining medical information of patients are not only inefficient and inconvenient for the patient but also for the commercial pharmaceutical entities that are interested in doing clinical studies to test their drugs prior to putting them out on the market. Firstly, though subjects who volunteer for clinical studies are willing to allow specific tests to be carried out on their DNA samples, they are not too keen on having the commercial pharmaceutical entity keep all their genomic data. Most of these subjects do not trust that these commercial pharmaceutical entities would solely use their genomic information for those specific tests and believe that the commercial pharmaceutical entities may also use their genomic information for other purposes. They will thus be very reluctant to share any of their genomic information with the commercial pharmaceutical entities in view of the lack of confidentiality problems that may arise. Secondly, these commercial pharmaceutical entities may not have the capacity to store and manage these exceedingly large amounts of genomic information from the multitudes of subjects. These above-mentioned problems make it very difficult for both the patients and/or commercial pharmaceutical entities to cash in on the progress in the field of biomedical research.

The field of medical informatics is dedicated to collection, optimizing the collection, storage, index processing, retrieval, analysis and use of any information obtained from an organism. However, most information collected is scattered. The information obtained from an individual can provide a wealth of knowledge in drug development. Due to the inherent genetic differences between even closely related individuals, administration of certain drugs or therapies is not necessarily guaranteed to yield the same result. Therefore, pharmaceutical companies are interested in producing drugs that are tailored to an individual based on his/her information obtained from the genomic data. This form of patient stratification is also important in salvaging drugs that might fail only because of severe but idiosyncratic drug reactions. Currently, companies like 23andme, Navigeneics, Myraid, Agendia, Genomic Health Inc., DNA direct and GeneDx disclose business methods that provide subjects with predictive tests involving genome screening and genetic variation analysis based on single nucleotide polymorphisms (SNP). However, scattered databases of medical information, participation by billions of users and limitations that prevent control of the medical information by the subjects cause the currently available methods of processing and/or providing such information to be inefficient and expensive. Therefore, there is a need in the art for a new and/or improved business model for processing and/or providing such information.

### SUMMARY OF INVENTION

The present invention addresses the problems above and provides a new and/or improved method, apparatus and/or system for processing and/or providing information obtained from at least one subject.

According to one aspect of the invention there is provided a method of processing and/or providing genomic, proteomic, biochemical, and/or metabolic information comprising:
collecting genomic, proteomic, biochemical, and/or metabolic information from at least one subject; and
processing of the information;
   wherein, the processed information is suitable to be provided to at least one recipient and wherein the subject has the ability to control the processing and/or providing of the information to the recipient.

According to another aspect of the present invention there is provided a method of processing and/or providing genomic, proteomic, biochemical, and/or metabolic information comprising:
collecting genomic, proteomic, biochemical, and/or metabolic information from at least one subject;
processing of the information; and
providing the processed information to at least one recipient
   wherein, the subject has the ability to control the processing and/or providing of the information to the recipient. The processing and/or providing of information may be carried out by a trusted agent. The recipient may be engaged in health care and/or research and development and may use the information for personalized medicine research and/or clinical trials. In particular, the method of processing and/or providing genomic, proteomic, biochemical, and/or metabolic information comprising collecting genomic, proteomic, biochemical, and/or metabolic information from at least one subject may comprise obtaining the information from analysis of at least one biological sample obtained from the subject. More in particular, the analysis of information may comprise genotyping; haplotyping; analysis of the subject's RNA; analysis of the subject's proteome; and/or analysis of the subject's metabolome. The analysis of the information may comprise comparing the information to at least one control.

Furthermore, the trusted agent may compare the information with genomic, proteomic, biochemical, and/or metabolic information in scientific databases, publications and/or disclosures to determine the predisposition to at least one disease and/or therapeutic regime of the subject. The trusted agent may also provide protected access to the processed information for secure use by the subject, wherein the subject is capable of controlling the processing and/or providing of information by user computer interface.

The at least one recipient may analyze the information provided, for use in health screening, detecting and/or diagnosis of diseases, therapeutic, cosmetic and/or surgical application and/or clinical trials. Accordingly, the trusted agent may send the information or partial information to more than one recipient. The information may be analyzed by the recipient(s) for tailored use by the subject. In particular, the at least one recipient may provide the analyzed information to at least one further recipient. The further recipient may be at least one second recipient contracted by the first recipient. In particular, the further recipient may need to be authorized by the trusted agent and/or the subject. More in particular, the further (second or contracted) recipient must be authorized by the trusted agent and/or the subject. The subject has the ability to control the providing of the information to the authorized further recipient. More in particular, the subject must give consent to the trusted agent before the trusted agent provides the information to the authorized further recipient. The subject may grant the trusted agent permission to control the providing of information to the authorized further recipient. The further recipient analyses the information provided, for use in health screening, detecting and/or diagnosis of diseases, therapeutic, cosmetic and/or surgical application and/or clinical trials and wherein the further recipient provides the analyzed information to the recipient who provides the analyzed information to the trusted agent. The trusted agent may provide the analyzed information to the subject periodically. The collected information and/or processed information may be stored in at least one computer readable medium. The information may also be processed in at least one computer readable medium.

According to another aspect of the invention, there is provided an apparatus for processing and/or providing genomic, proteomic, biochemical, and/or metabolic information comprising:
at least one collecting module for collecting at least one genomic, proteomic, biochemical, and/or metabolic information collected from at least one subject;
at least one processing module for processing the information;
at least one providing module for providing processed information to at least one recipient
   wherein, the processing and/or providing module may comprise at least one user interface module adapted to receive user commands from the subject for controlling the processing and/or providing of information to the recipient. In particular, the collecting module may obtain at least one biological sample from the subject. More in particular, the processing module may process, analyse and/or compare the processed information with scientific databases, publications and/or disclosures. More in particular, the user interface module may provide secure access for the subject.

According to yet another aspect there is provided a system for collecting, processing and/or providing genomic, proteomic, biochemical, and/or metabolic information comprising:
at least one first agent terminal adapted to collect genomic, proteomic, biochemical, and/or metabolic information collected from at least one subject; and
at least one second agent terminal adapted to process the information;

at least one third agent terminal for providing the processed information to at least one recipient terminal

wherein, the second and/or third agent terminal comprises a user interface module adapted to receive user commands from the subject for controlling the processing and/or providing of information to the recipient terminal. In particular, the collecting of the information is by collecting at least one biological sample from at least one subject. More in particular, the processing of the information is by comparing the processed information with scientific databases, publications and/or disclosures.

According to a further aspect, there is provided a computer readable medium carrying computer readable code for controlling a system to carry out the method of processing and/or providing genomic, proteomic, biochemical, and/or metabolic information comprising:
collecting genomic, proteomic, biochemical, and/or metabolic information from at least one subject;
processing of the information;
providing the processed information to at least one recipient
   wherein, the subject has the ability to control the processing and/or providing of the information to the recipient.

### BRIEF DESCRIPTION OF THE FIGURES

FIG. 1 depicts the approach presently available and/or used wherein the medical information is scattered for example in various hospitals and/or medical institutes and limits patient's (subject) control of his/her private information.

FIG. 2 depicts the proposed method of the present invention wherein the medical information of at least one subject is collected and stored in a secure data warehouse by a trusted agent who may also be a medical advisor and/or medical concierge. The information is then provided to at least one recipient comprising the doctors in research and/or pharmaceutical agencies and/or doctors in the hospitals, with the approval of the subject.

FIG. 3 depicts the system model of the present invention. The trusted agent or personal genomic sciences processor may be hired by a pharmaceutical company and/or a recipient of the information. The trusted agent carries out the collection and processing of the information for example, genomic sequences and/or information from the entire cohort or the subjects of a study. The processed information is securely stored with the trusted agent for a delimited period of time and the source of the processed information was obtained for example the DNA sample is destroyed. The trusted agent provides and/or releases the processed information in parts to the pharmaceutical company and/or recipient with the approval of the subject periodically.

### DETAILED DESCRIPTION OF THE INVENTION

The present invention provides at least one method, apparatus and/or system for processing and/or providing information obtained from at least one subject. In particular, the method, apparatus and/or system comprises a trusted agent wherein the agent collects information from at least one subject and processes the information. The trusted agent may further provide the processed information to at least one recipient. The recipient may be engaged in health care and/or research and development agent. The trusted agent further provides the subject with secure access to the information such that the subject can limit the providing of the processed information.

For the purposes of the present invention the term “trusted agent” refers to any person capable of collecting and/or processing a biological sample for genomic, proteomic, biochemical, and/or metabolic information from the subject. The trusted agent may belong to an agency that is involved in the collecting and/or processing and further providing of the processed information. The trusted agent may comprise of medical doctors and/or biomedical scientists or the trusted agent may employ and/or consult medical doctors and/or biomedical scientists.

For the purposes of the present invention the term “subject” as used herein refers to any individual capable of providing a biological sample. It should be noted that for the purposes of the present invention, subject and patient is used interchangeably. A person skilled in the art will know how to select subjects based on their amenability to a particular treatment, or their susceptibility to a particular disease.

For the purposes of the present invention the term “biological sample” may comprise genomic, proteomic, biochemical, and/or metabolic information of the subject. Examples of biological samples include but are not limited to blood, DNA, RNA, urine, serum, Cerebrospinal fluid, Peripheral Blood Mononuclear Cells, Cells and the like.

For the purposes of the present invention the term “medical information” refers to any information with regard to the health of the subject. Examples of medical information include but are not limited to genome, RNA and proteome sequences, X-Rays, past diagnosis and prescriptions, health records and the like.

For the purposes of the present invention the term “recipient” refers to an entity interested in the processed information provided by the trusted agent. For example, the recipient may be involved in the health care industry, for example in hospitals and/or medical institutes and the like. Examples of recipients include but are not limited to doctors, nurses, technicians and other health caretakers. “Recipient” also refers to those entities involved in research and development like the pharmaceutical industry and/or company, researchers in academics and industry, researchers and doctors in the hospitals and/or in other agencies that may be involved in personal genome sciences service and/or the healthcare service.

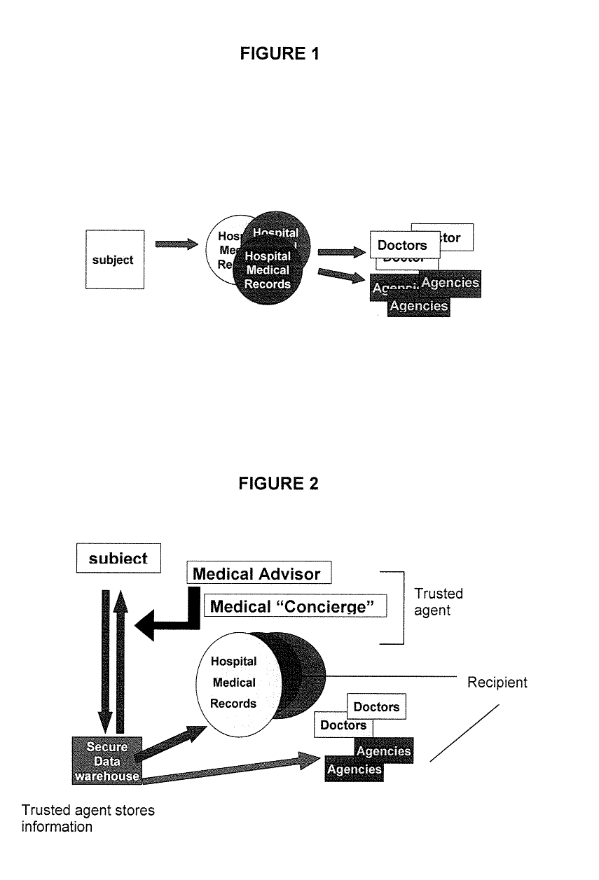

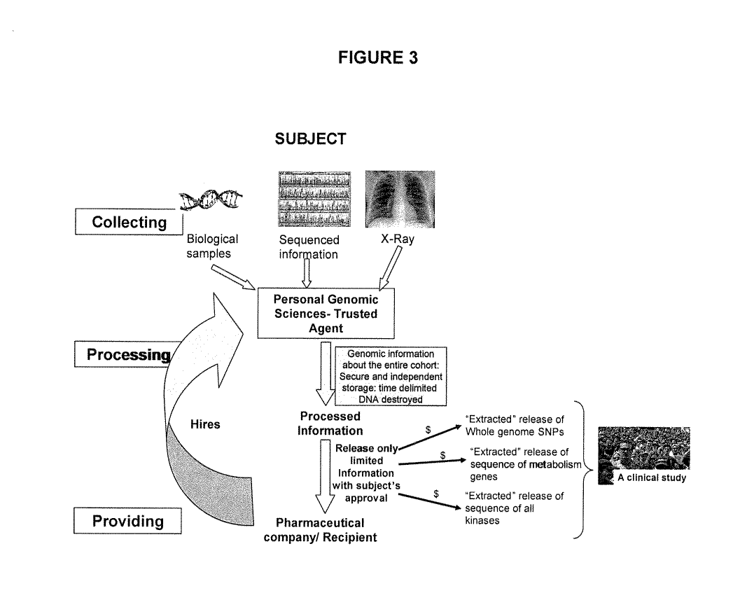

The present invention will now be described more in detail by the use of figures that are provided solely to provide context and for the detailed description and, as such, is not limiting. FIG. 2 and FIG. 3 best describe the invention and details are provided in the subsequent detailed description.

“Collecting” of Information

According to one embodiment, a subject, as shown in FIGS. 1 and 2, contacts a “trusted agent”. Alternatively, the subject may be contacted by the trusted agent. In FIG. 2, the trusted agent comprises a medical adviser and/or a medical concierge. The trusted agent may collect and/or store the information from a subject in a computer readable medium referred to as secure data warehouse. The trusted agent may collect a biological sample from the subject and/or collect medical information related to the subject from medical hospitals, medical institutes and/or the subject it-self. The storing of information in such a secure data warehouse ensures that the subject may control the processing and/or use of the information.

In FIG. 3, the trusted agent who plays a part in the field of “personal genomic sciences” is shown to be the middle person between the recipient, in this case a pharmaceutical company, and the subject. The field of personal genomic sciences refers to processes dedicated to obtaining complete genomes and medical records of individuals to aid in the process of personalized medicine.

“Processing” of Collected Information;

The agent may process the information for further analysis to provide medical advice to the subjects. Processing of the collected information may include but is not limited to sequencing of the DNA sample and/or running tests on biological samples to determine their components and the concentrations of these components. These tests provide personalized information related solely to the subject. The processed information may be stored in a computer readable form for access by the subject in a secure data warehouse such that the subject has the ability to control further use of the information. The biological sample used to obtain the processed information is then destroyed.

The processing of information may involve an interface such that the subject can limit the processing of information by the trusted agent. Therefore, the stored information may provide secure access to the subject who has the right to limit access to the information by the trusted agent and recipient and the processing of the information by the trusted agent.

The trusted agent plays the role as a medical concierge and/or medical advisor as shown in FIG. 2. The subject may ask for specific tests and pay for these tests and/or the consultation as they are provided to the subject. The subject may also subscribe to a service provider such as a “genetic information services” provided and/or hosted by the trusted agent which may send the subject periodic updates about new genetic tests emerging from the most current research. The trusted agent also becomes a genetic advocate for the subject in cases involving legal interpretation. This approach allows subjects to use the processed data, for example the sequence data, and the diagnostics and predictive medicine services provided by the trusted agent at the time of sequencing and/or in the future for one and/or diagnosis of multiple diseases based on the most current research findings. Since the sequence of the complete genome of the subject would be available, no further genetic tests may be needed and the subject's DNA sample may be destroyed thus providing the subject a security in knowing that his/her biological samples are not going to be used for other illegitimate purposes (FIG. 3). The processed information may then be stored in a secure and independent storage medium and this may be a computer readable medium.

The subjects may for example request that the medical doctors and biomedical scientists of the trusted agent and/or agency provide an analysis of the susceptibility of the subject to various genetically linked diseases like Breast Cancer (BC) and Parkinson Disease (PD), but not limited to these diseases. The trusted agent may utilize the most current knowledge in this area like BC and PD to search for mutations or structural variations in/near genes that are associated with BC and PD e.g. BRCA1 & BRCA2 (for BC) and LRRK2 (for PD). The trusted agent may then analyze the subject's genome based on SNPs association studies that indicate risks of getting BC and PD based on scientific knowledge available at the time of testing (FIG. 3). The trusted agent may then provide consultation, referred to as medical concierge service or medical advice, to the subject to explain the predisposition of the subject to certain diseases based on the interpretation of their processed information (FIG. 2).

In one embodiment, the trusted agent may send the availability and/or results of newly available genetic tests to the subjects who have paid a fixed subscription fee to the genetic information service. This service sends periodic information about new genomic tests emerging from the most current research. This service may inform subscribers of the service of the latest genomic tests available and/or the costs of them and/or the accuracy of these tests. The service may send this information through an online journal, magazine, E-mail and/or through post to the subscriber. The service may also sieve this information and only send information relevant to the subject i.e. the service may send information with regard to the availability of new tests for diseases that the subject has a higher predisposition to based on the medical history of the subject. If new gene(s) discovered indicate susceptibility to a particular disease, (e.g. mutated LRRK2 gene as an indicator of PD) and substantially sufficient validation work has been done to confirm that the mutation in the gene is associated with the disease, the trusted agent may send the availability of the genetic tests to the subscribed subject. The subject may then decide if he/she wishes to pay the trusted agent for the test to be carried out on his/her genomic information. The trusted agent may then carry out the selected new tests on the subject's genomic information and send the subject his/her results. The results may be sent periodically based on the new tests available and tests chosen by the subject. Alternatively, the subject may pay a fixed fee to have the tests carried out as and when they are available without the subject having to provide separate instructions to the trusted agent for each test to be carried out. In this case, the trusted agent may send the results of the genetic tests to the subject every time a new test is available. In another embodiment, the trusted agent may authorize a further agent to gather the information on newly available genetic tests and provide the information to the subject.

The trusted agent may also become an advocate or advisor for the subject in cases involving legal interpretation. In situations where subjects are involved in legal disputes like criminal offences, the court may admit evidence indicating subject's tendency to violence, for example, or tendency to behave in a particular way that can be predicted based on their genomic sequence information. Under such circumstances, the trusted agent may assist the court or the subject's legal council in the interpretation of the subject's genetic predisposition to behave in a particular manner using most current research findings in behavioral genetics. One example in the prediction of propensity to violence is the gene that that codes for monoamine oxidase A (MAOA). Courts have admitted future dangerousness predictions into evidence. There have been attempts to discriminate between defendants who are innately criminal and those who acted merely by force of circumstances, i.e. those whose crimes would not pose a future danger to society. It has been argued that future dangerousness predictions are required in a wide range of proceedings, including civil commitments, juvenile adjudications, bail hearings, competency hearings, insanity determinations, and sentencing (Erica Beecher-Monas and Edgar Garcia-Rill, 2006).

“Providing” of Processed Information:

According to a further embodiment, the information processed by the trusted agent is provided to at least one recipient. The recipient may hire the trusted agent as shown in FIG. 3 to provide the processed information. The recipient may analyse the processed information by standard methods like genotyping, haplotyping, RNA analysis, metabolome analysis and/or proteome analysis. A person skilled in the art will be well versed in these techniques. Alternatively, the recipient may hire the trusted agent to carry out the analysis it requires. The recipient may compare the resultant information with suitable controls. The “control” may be the results obtained from the processing and analysis of any biological sample or information obtained that may be used as a reference. The results obtained from the subject may be compared with the control for assessing any deviation from the reference.

Since pharmaceutical companies seek to conduct clinical trials and/or studies (FIG. 3) and assess the genetic predisposition for adverse reaction of the subjects to certain drugs or to improve efficacy of the drug they are testing, the provided information is of interest to aid in future research. However, since the subjects will object to having their complete genomic information held by a commercial pharmaceutical company, the company may need to engage the trusted agent to function as a trusted third party to safeguard the subject's genetic information and to release only what has been agreed upon based on the informed consent of the subject as shown in FIG. 3. The trusted agent holds the processed information in a secure data warehouse stored in a computer readable form for a delimited period of time dependent on the subject.

The providing of information may involve an interface such that the subject can limit the providing of information to at least one recipient. Therefore, the stored information may provide secure access to the subject who has the right to limit access to the information by the trusted agent and the providing of the information to the recipient. The subject may further choose to provide certain information only and only to the certain recipients.

The pharmaceutical company may then pay for each new in silico (computational) screen of the archived genomic information as shown in FIG. 3. The subjects will be informed of each new genetic screen and the subject may withdraw from the study and demand that the genetic information be erased. Further, the payment from the pharmaceutical company to the trusted agent may be graduated, i.e. release of sequence information is upon request and payment by the pharmaceutical company. The sequence information may be accessed electronically wherein the subject may have at least one password and home decrypters to access sequence information and medical advice for security purposes. The information sent out to the pharmaceutical company may be filtered and always sent in an anonymous manner. The pharmaceutical company may receive the processed information which may be useful for a specific clinical study but may not receive the details of the subject. The subject may always remain anonymous to the pharmaceutical company. This ensures that the pharmaceutical company will not be able to exploit the processed information of the subject for other clinical studies without the consent of the subject. The subject may thus be keener on taking part in clinical studies knowing that the pharmaceutical companies do not have all their personal details and that their whole genome sequence will not be accessible to the pharmaceutical company.

The type of sequence information released to the pharmaceutical company may be in the form of whole genome SNPs information or sequences of genes of any particular class for example metabolic genes, kinases and the like. Such information may be analysed by single-SNP or multiple-SNP haplotype association analysis (Yi Li et al, 2007). The information may also reveal sequence deletions, inversions, sequence repeats and fused genes and other structural variations. The pharmaceutical company may use this information to help identify biomarkers, stratify patients or predict the percentage of patients that will respond to drug candidates during drug development and clinical trials, or to stratify patients during rescue of failed drugs. This graduated flow of information implies that the costs to pharmaceutical company will be based on amount of information released by the trusted agent with the approval of the subject.

In another embodiment, payment to the trusted agent may be made electronically. The trusted agent may set up a computer interface that allows for online transactions and/or payments to be made by the subject to the trusted agent without having to meet the trusted agent. The payments may be made to the trusted agent by the subject based on the number of tests that the subject wishes to carry out. The pharmaceutical company may also pay the trusted agent via a computer interface. The payment to the trusted agent is graduated based on the information released to the pharmaceutical agent by the trusted agent.

According to a further embodiment, the trusted agent may use the processed information and separate the subjects into groups. These groups may comprise subjects with similarities. Examples of similarities include but are not limited to characteristics, family background, medical background, diseases, structural differences in genes, genetic expression and the like. Processed information from these groups of subjects with similarities may be provided to the recipient when required with the approval of the subject. For example one group may be made up of subjects with diabetes. The processed information from the subjects of this group may be selected by a pharmaceutical company that may be interested in doing a clinical trial of a latest drug to treat diabetes. The group made up of subjects with diabetes would be the most appropriate for such a clinical trial.

According to a further embodiment, the present invention involves the providing of clinical information obtained by the recipient back to the trusted agent who in turn may provide the information to the subject. The information may be stored in a computer readable form in a secure and independent storage medium as shown in FIG. 3. In this way, the trusted agent may also provide a Medical Concierge service to the subjects as shown in FIG. 2 on the information obtained from the analysis of the information carried out by the recipient.

The present invention also provides an apparatus for processing and/or providing genomic, proteomic, biochemical, and/or metabolic information by use of at least one collecting module, at least one processing module and/or at least one providing module The “collecting module” may not be limited to collecting information from a biological sample. They may comprise data acquisition features to explore potential physical conditions and medical events, and to pinpoint sources of potential medical problems. These may also include electrical data acquisition which detect and record the operation of systems of the body and, to some extent, the response of such systems to situations and stimuli. The collecting module may also comprise more sophisticated systems that provide images of the body, including internal features which could only be viewed and analyzed through surgical intervention before their development, and which permit viewing and analysis of other features and functions which could not have been seen in any other manner. The “ processing module” may further process the collected information for storage into a computer readable form. The “providing module” may use an interface such that the subject can limit the providing of information to at least one recipient. Therefore, the stored information may provide secure access to the subject.

A further embodiment provides a system for collecting, processing and/or providing genomic, proteomic, biochemical, and/or metabolic information comprising at least one first agent terminal, at least one second agent terminal and at least one third agent terminal. The “first agent terminal” may not be limited to collecting information from a biological sample. The terminal may comprise data acquisition features to explore potential physical conditions and medical events, and to pinpoint sources of potential medical problems. These may also include electrical data acquisition which detect and record the operation of systems of the body and, to some extent, the response of such systems to situations and stimuli. The first agent terminal may also comprise more sophisticated systems that provide images of the body, including internal features which could only be viewed and analyzed through surgical intervention before their development, and which permit viewing and analysis of other features and functions which could not have been seen in any other manner. The “ second agent terminal” may further process the collected information for storage into a computer readable form. The “third agent terminal” may use an interface such that the subject can limit the providing of information to at least one recipient. Therefore, the stored information may provide secure access to the subject.

### REFERENCES

Erica Beecher-Monas and Edgar Garcia-Rill; Genetic Predispositions of Future Dangerousness: Is There a Blueprint for Violence?: Law and Contemporary Problems, Vol 69:301, Winter/Spring 2006.

Yi Li et al; Association Mapping via Regularized Regression Analysis of Single-Nucleotide-Polymorphism Haplotypes in Variable-Sized Sliding Windows: The American Journal of Human Genetics, Vol 80 April 2007.

1. A method of processing and/or providing genomic, proteomic, biochemical, and/or metabolic information comprising:
i. collecting genomic, proteomic, biochemical, and/or metabolic information from at least one subject;
ii. processing of the information; and
iii. providing the processed information to at least one recipient
wherein the subject has an ability to control the processing and/or providing of the information to the recipient.

2. The method according to claim 1, wherein the processing and/or providing of information is carried out by at least one trusted agent.

3. The method according to claim 1, wherein the recipient is engaged in health care and/or research and development.

4. The method according to claim 1, wherein the providing of information to the recipient is done in an anonymous and confidential manner, wherein the identity of the subject is kept confidential.

5. The method according to claim 1, wherein the step (i) of collecting comprises obtaining the information from analysis of at least one biological sample obtained from the subject.

6. The method according to claim 5, wherein the analysis of the information comprises genotyping; haplotyping; analysis of the subject's RNA; analysis of the subject's DNA; analysis of the subject's proteome; and/or analysis of the subject's metabolome.

7. The method according to claim 5, wherein analysis of the information comprises comparing the information to at least one control.

8. The method according to claim 5, wherein at least one trusted agent compares the information with genomic, proteomic, biochemical, and/or metabolic information in scientific databases, publications and/or disclosures to determine the predisposition to at least one disease and/or therapeutic regime of the subject.

9. The method according to claim 2, wherein the trusted agent provides protected access to the information for secured use by the subject.

10. The method according to claim 9, wherein the subject is capable of controlling the processing and/or providing of information to the recipient by user computer interface.

11. The method according to claim 3, wherein the recipient analyses the information provided, for use in health screening, detecting and/or diagnosis of diseases, therapeutic, cosmetic and/or surgical application and/or clinical trials.

12. The method according to claim 11, wherein the analyzed information is tailored by the recipient for the subject.

13. The method according to claim 11, wherein the recipient provides the analyzed information to at least one further recipient wherein, the subject has the ability to control the providing of the information to the further recipient.

14. The method according to claim 13, wherein the further recipient analyses the information provided, for use in health screening, detecting and/or diagnosis of diseases, therapeutic, cosmetic and/or surgical application and wherein the recipient provides the analyzed information to at least one trusted agent.

15. The method according to claim 14, wherein the trusted agent periodically provides the analyzed information to the subject.

16. The method according to claim 2, wherein the trusted agent sends the subject periodic updates on means available to analyse the information based on new genetic tests emerging from the most current research.

17. The method according to claim 16, wherein the periodic updates are available at a fee paid to the trusted agent by the subject.

18. The method of claim 1, wherein the collected information and/or processed information is stored in at least one computer readable medium.

19. The method of claim 1, wherein the information is processed in at least one computer readable medium.

20. A method of processing and/or providing genomic, proteomic, biochemical, and/or metabolic information comprising:
i. collecting genomic, proteomic, biochemical, and/or metabolic information from at least one subject; and
ii. processing of the information; and
wherein the processed information is suitable to be provided to at least one recipient and wherein the subject has the ability to control the processing and/or providing of the processed information to the recipient.

21. Apparatus for processing and/or providing genomic, proteomic, biochemical, and/or metabolic information comprising:
(i) at least one collecting module for collecting genomic, proteomic, biochemical, and/or metabolic information collected from at least one subject;
(ii) at least one processing module for processing the information; and
(iii) at least one providing module for providing the processed information to at least one recipient
wherein the processing and/or providing module comprises at least one user interface module adapted to receive user commands from the subject for controlling the processing and/or providing of information to the recipient.

22. The apparatus according to claim 21, wherein the collecting module analyses at least one biological sample from at least one subject.

23. The apparatus according to claim 21, wherein the processing module compares the information with scientific databases, publications and/or disclosures.

24. The apparatus according to claim 21, wherein the user interface module provides secure access for the subject.

25. A system for collecting, processing and/or providing genomic, proteomic, biochemical, and/or metabolic information by at least one trusted agent wherein the system comprises:
(i) at least one first terminal adapted to collect genomic, proteomic, biochemical, and/or metabolic information collected from at least one subject; and
(ii) at least one second terminal adapted to process the information; and
(iii) at least one third terminal for providing the processed information to at least one recipient terminal
wherein the second and/or third terminal comprises a user interface module adapted to receive user commands from at least one subject for controlling the processing and/or providing of information to the recipient terminal.

26. The system according to claim 25, wherein the collecting of the information is by analyzing at least one biological sample from at least one subject.

27. The system according to claim 25, wherein the processing of information is by comparing the information with scientific databases, publications and/or disclosures.

28. A computer readable medium carrying computer readable code for controlling a system to carry out the method of claim 1.
